(19) United States
(12) Patent Application Publication
(10) Pub. No.: US 2016/0259810 A1
(43) Pub. Date: Sep. 8, 2016

(54) GLOBAL FILE INDEX

(71) Applicant: Hewlett-Packard Development Company, L.P., Houston, TX (US)

(72) Inventors: Roy Lee Troutman, Ft. Collins, CO (US); Paul Boerger, Ft. Collins, CO (US); Gregory Mark Hughes, Ft. Collins, CO (US); Paul Michael Anderson, Ft. Collins, CO (US)

(21) Appl. No.: 14/641,229

(22) Filed: Mar. 6, 2015

(51) Int. Cl. G06F 17/30

(52) U.S. Cl. CPC G06F 17/30174

(57) ABSTRACT

According to an example, to index computing device files, a global index update is received from a first registered device. The global index update from the first registered device is stored and propagated to a second registered device. In an example, an action associated with the global index update is determined. In an example, the action may be propagated to the second registered device. In another example, a remote server is crawled and the global index is updated.

### BACKGROUND

Computing systems, devices, and electronic components in general may utilize content in the form of digital files. Systems may create files, store files, or receive files, as examples. A user may retain or have access to a large number of files stored across a multitude of devices, systems, ecosystems, accounts, and/or platforms.

### BRIEF DESCRIPTION OF THE DRAWINGS

FIG. 1 illustrates a network-based system for file access across devices, according to an example of the present disclosure;

FIG. 2 illustrates a flowchart of propagating a global index update and action associated with the global index update, according to an example of the present disclosure;

FIG. 3 illustrates a flowchart of crawling a remote server and updating a global index based on the remote server crawl, according to an example of the present disclosure;

FIG. 4 illustrates a schematic representation of a computing device that may be used as a platform for receiving a global index update and a push notification of an action associated with the global index update, according to an example of the present disclosure.

### DETAILED DESCRIPTION

Various examples described below provide for propagating a global index of software files across devices to allow for the access, organization, and execution of files across devices, systems, networks, accounts, and platforms. In some examples, a global index may be replicated across all devices, with files stored on distributed or federated storage and/or on remote servers. According to some examples, the global index may also include files crawled from a source, e.g., a remote server such as a social media site associated with an account of a user.

As the number of software files associated with a typical computing user continues to grow, the organization, management, access, and indexing of such files may be a challenge. The challenge may be further compounded by an ever-increasing number of systems, devices, accounts, platforms, and other computing resources available to a single user, and even more so with a group of users that may wish to share files or collaborate.

As one example, a computer user may own a desktop computer, laptop computer, smartphone, and tablet, all of which may receive, store, create, and otherwise process software files. In addition, the user may store files on cloud services or systems, such as on an e-mail server, cloud storage sites, social media sites, photography sites, music services, and other remote servers. The files may be stored across different computing devices and systems in various formats, on different platforms, and across local and/or distributed storage systems. As used herein, a “computing device” or “device” may be a desktop computer, notebook computer, workstation, tablet computer, mobile phone, smart device, printing device, server, blade enclosure, or any other processing device or equipment in various formats, on different platforms, and across local and/or distributed storage systems.

In some examples, a user may not know the location of a file, and may need to search across multiple devices to locate the desired file. For example, a user may know that the user has possession of an image file or remember seeing a file, but may need to search a local camera roll on a device such as a smartphone, a folder on a laptop computer, and a social media site to determine the location of the file. Aside from organizational challenges and inefficiencies, such a user is also faced with issues relating to sharing, backup, printing, and other actions the user may wish to perform on a file on a given device.

Cloud storage and other distributed file solutions may allow a user to upload files to a central storage area or repository, but may require manual intervention, may result in the replication of files, and may result in a single point of failure. Examples described herein relate to globally indexing files and/or metadata across an entire data collection of a user, such as the example of a user with a desktop computer, laptop computer, smartphone, and tablet, as well as files on an e-mail server, cloud storage sites, social media sites, photography sites, music services, and other remote servers.

According to an example, to index software files on a computing device, a global index update is received from a first registered device. The global index update from the first registered device is stored and propagated to a second registered device. In an example, an action associated with the global index update is determined. In an example, the action may be propagated to the second registered device. In some examples, a remote server is crawled and the global index is updated.

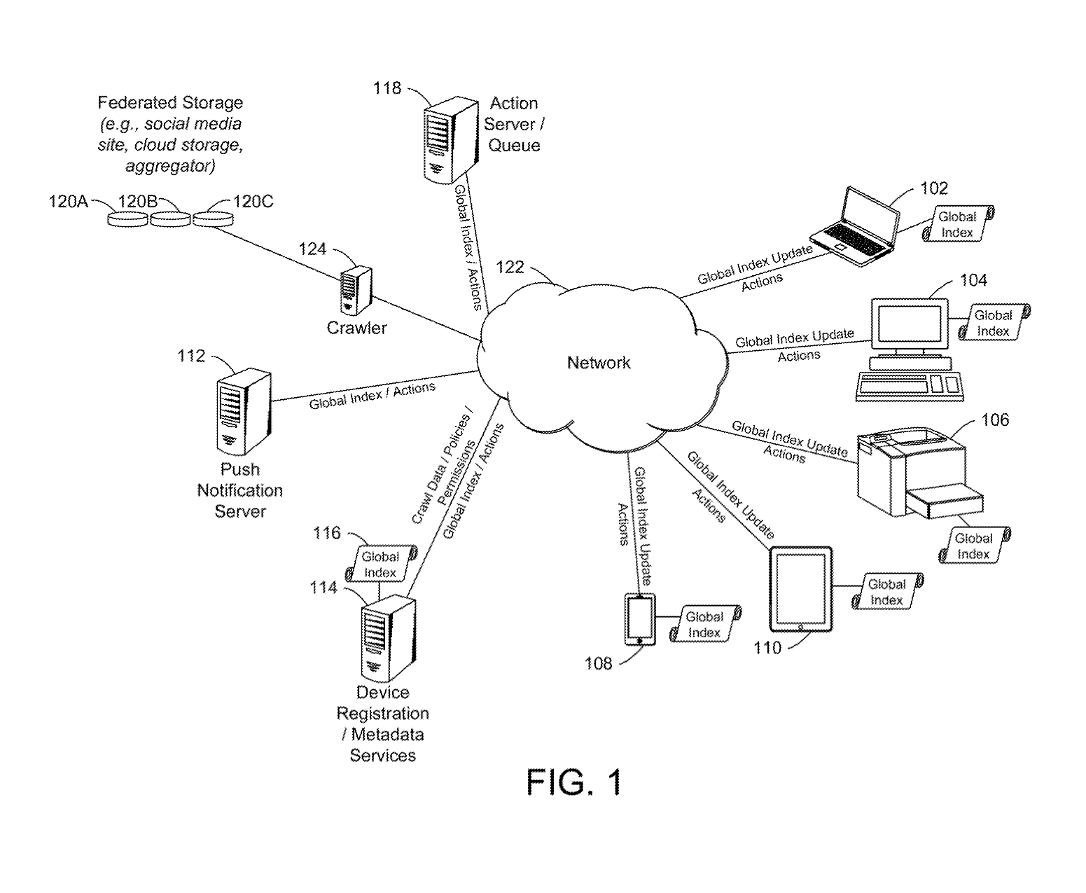

FIG. 1 illustrates a network-based system for file access across devices, according to an example of the present disclosure. In some examples of FIG. 1, a global index on one device (e.g., device 102), is updated and propagated to, e.g., devices 104-110, and server(s), e.g., server 114.

The network-based system may comprise device(s) such as laptop 102, desktop computer 104, printer 106, smartphone 108, and tablet 110, or other computing devices as discussed above. Devices 102-110 may be configured to work with a local or remote server to enable services such as cloud storage and/or cloud printing. Devices 102-110 may also comprise a mechanism for entering or receiving user authentication credentials, such as a touch screen or input for receiving a physical token or biometric input, or wired or wireless signals.

Devices 102-110 may maintain a local index of files stored on the device. The local index may contain metadata related to files on the device, including file name, file type, file size, file location, and other attributes. In some examples, the local index may be identical to, or maintained as part of, a global index of files known to be accessible to the user or to device. For example, the global index (or “global file index”) may contain metadata related to all files that a user of the device is entitled or permissioned to access across an ecosystem of devices, systems, networks, accounts, and platforms, as discussed below in more detail. In some examples, the global file index may also include all files visible to a user, even if the user is not permissioned to read or write to the file.

Devices 102-110 may communicate with a server, such as servers 112, 114, and 118, which may be local servers (e.g., a server maintained in an enterprise environment, or remote servers, e.g., a cloud server). Servers 112, 114, and 118 may be coupled to or communicate with a database or other electronic storage (“database”).

Server 114 may be, for example, a user registration or device registration server and an index/metadata services server. For example, devices 102-110, or the users of those devices, may register with server 114, which may then serve as a repository or hub for authenticating devices and servers, and propagating information between devices 102 and 110 and servers 112, 114, and 118. Server 114 may receive, for example, an update to a global index from a device, store or update the index locally as global index 116, and then propagate the global index update to other devices. Server 114 may also enforce rules, permissions, or policies associated with global indexes, or files associated with global indexes. Servers 112, 118, and 124, discussed below, may also register with server 114.

Server 112 may be a push notification server. In an example, server 112 may receive an update or global index update from server 114, or directly from a device 102-110. Server 112 may then push the update to another server or device. In another example, server 112 may receive an update or action from server 118, discussed below, and push the update or action to a device 102-110.

Server 118 may be an action server or job queue. In an example, files stored on the servers and devices of FIG. 1 may have actions associated with them. For example, one action may be to copy a file from one device to another. Another example of an action may be to print a file when a device boots. Actions may be determined based on metadata stored in the global index, based on user preferences or instructions, or based on policies and rules. For example, a rule on server 114 may generate an action in a job queue on server 118 to transmit a global index update with an associated print job to printer 106 when printer 106 comes online, but not to smartphone 108 since smartphone 108 is not capable of printing.

Storage 120A-C, which may be local, distributed, or federated storage, or a combination thereof, may store files associated with a device, user, or user account, or generally files which a user wishes to access. Storage 120-C may be coupled directly to any device shown in FIG. 1, or may be coupled via a network connection. More specifically, storage 120A-C may be storage associated with cloud services (e.g., services provided by one or more remote servers accessible over a network) or systems, such as e-mail servers, cloud storage sites, social media sites, photography sites, music services, and other remote servers.

Server 114, crawler 124, or devices 102-110 may crawl storage 120A-C or other devices or servers for data and files to be added to the global index. Crawling may include, for example, browsing or indexing directories of files using, for example, a bot or “spider”. In some examples, crawling may include reading file folders, files, file names, and/or metadata associated with files and determining if the file was previously read or visited by the crawler. A crawler may also include a re-visit policy to determine when or how often to revisit a file to update a global index if, for example, a file or file properties change.

In some examples, the server or device crawling any of storage 120A-C may log into an account associated with a user, such as a social media account, to crawl only files to which the user has permissions to read. In some examples, crawler 124 may be a dedicated server for crawling servers, federated storage, distributed storage, local storage, websites, and other data storage repositories.

Devices 102-110, servers 112, 114, 118, and 124, and storage 120A-C may communicate via a network 122, which may be any public or private network such as the internet, a cloud, a local area network, a wide area network, or other communication or transmission network, or a combination thereof.

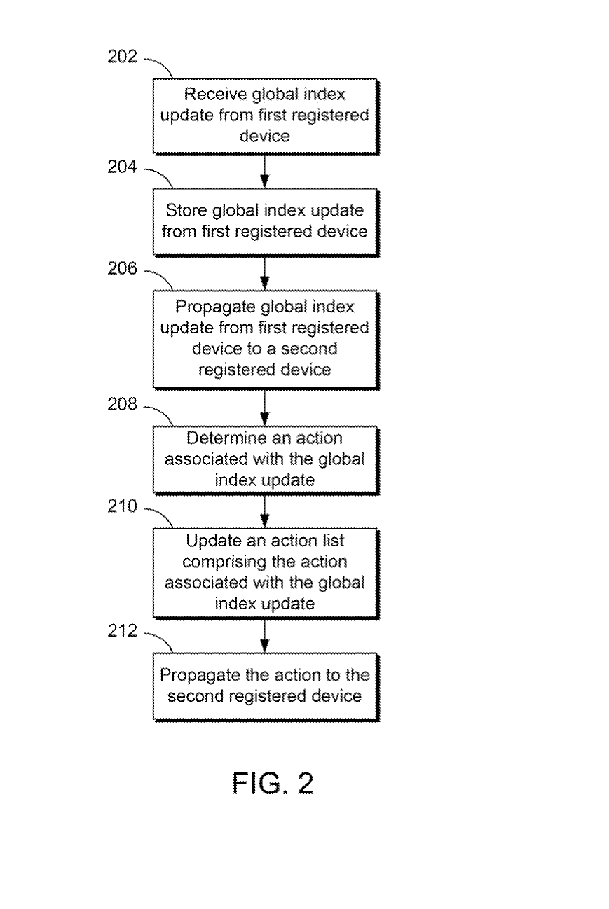

FIG. 2 illustrates a flowchart of propagating a global index update and an action associated with the global index update, according to an example of the present disclosure. The flow of FIG. 2 may be implemented as hardware or as a combination of hardware and software as machine-readable instructions, such as in server 114. For example, the flow of FIG. 2 may represent executable instructions stored on machine-readable storage media and executed by a processor on server 114.

In block 202, a global index update is received from a first registered device. The index may be received at, for example, server 114 of FIG. 1. The first registered device may be, for example, any of devices 102-110 in FIG. 1.

In some examples, the global index update received in block 202 may be a copy of the entire global index. In other examples, the global index update may be a subset of the entire global index, or a delta file (i.e., a file comprising only changes made to another file as opposed to reproducing the entire file). As discussed above, the global index update may represent metadata associated with software files.

In block 204, the global index update received from the first registered device is stored, e.g., on server 114. In the event that the update comprises a copy of the entire global index, the index may be entirely replaced, and a historical version of the previous global index may be retained. In the event that the update comprises only a subset of the global index or a delta, the copy on, e.g., server 114, may be updated only with the changes indicated in the delta file. In examples, various data storage, rollback, time stamping, and archival techniques may be used.

In block 206, the global index update received from the first registered device is propagated to a second registered device. For example, a global index update may be received from laptop 102 on server 114, and propagated to desktop computer 104 from server 114. In other examples, laptop 102 may propagate the update to server 114 directly and also to desktop computer 104 directly.

In block 208, an action associated with the global index update is determined. An action may be, for example, an instruction to open, fetch, retrieve, copy, delete, backup, archive, share, print, e-mail, SMS, or otherwise process a file. Actions may also be based on a user action, user preference, rules, policies, permissions, time, or a device state. For example, an action may be to print a file when a device boots, if the boot occurs between 9 AM and 5 PM. The action may be determined in block 206 by, e.g., server 114, or by reading an action received from a first registered device, e.g., laptop 102.

In block 210, an action list comprising the action associated with the global index update may be updated. The action list may comprise a queue of actions or jobs, and may be stored on server 114 or a separate server, e.g., server 118.

In block 212, the action is propagated to the second registered device. For example, an action to backup a file on smartphone 108 may be propagated to desktop computer 104.

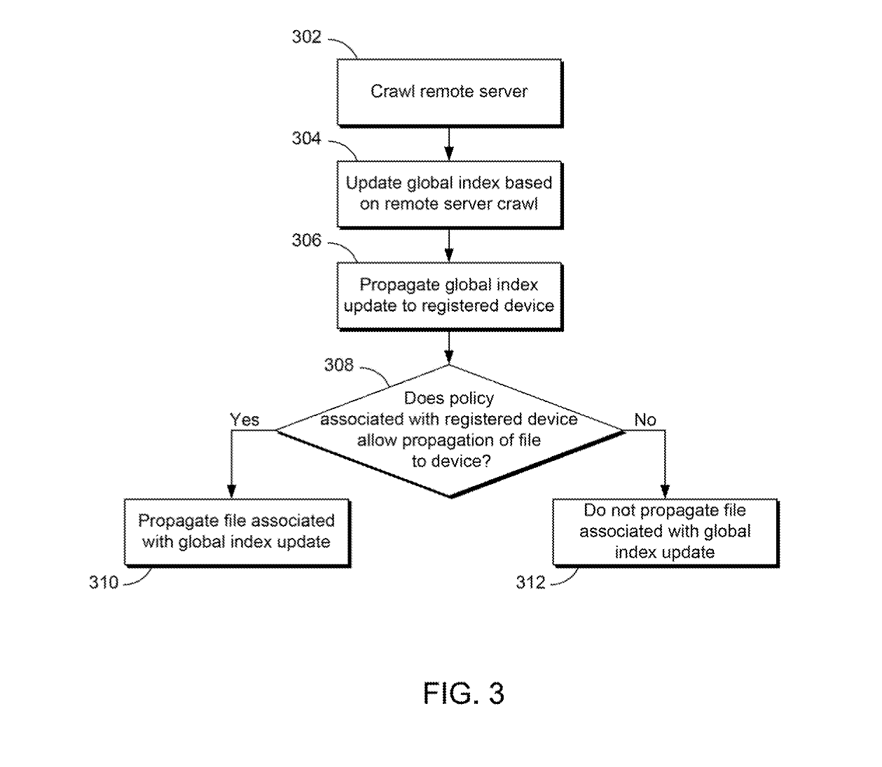

FIG. 3 illustrates a flowchart of crawling a remote server and updating a global index based on the remote server crawl, according to an example of the present disclosure. The flow of FIG. 3 may be implemented as hardware or as a combination of hardware and machine-readable instructions, such as in server 114. For example, the flow of FIG. 3 may represent executable instructions stored on machine-readable storage media and executed by a processor on server 114 or crawler 124.

In block 302, remote storage is crawled. The remote storage may be, e.g., any location where the user may store files, such as on cloud services or systems, e.g., e-mail servers, cloud storage sites, social media sites, photography sites, music services, and other remote servers. For example, storage 120A-C in FIG. 1 may be crawled.

In block 304, the global index is updated based on the remote server crawl. For example, the crawl may discover a series of new files accessible by or visible by a social media account of a user, and those files and their associated metadata or locations may be stored in the global index.

In block 306, the global index update is propagated to a registered device or devices. For example, the update may be propagated from server 114 to devices 102-110.

In block 308, a determination is made as to whether a policy associated with a registered device allows propagation of a file associated with a global index update to the device. The policy may be based on, for example, whether the device is capable of processing the file associated with the global index update. If, for example, the device is capable of processing the file (or if another policy or rule is satisfied), flow proceeds to block 310 and the file is propagated to the device. If the device is not capable of processing the file, flow proceeds to block 312 and the file is not propagated.

In various examples, whether a device is capable of processing a file may be determined based on whether the device can retrieve, store, open, or otherwise process a file, such as whether a print job should be sent to a device not capable of printing. Such a determination may be made based on, for example, device properties stored on a device, in the global index, or elsewhere. Similarly, whether a file requires a certain processing capability made be stored in the file itself, in the global index, on a device, or elsewhere.

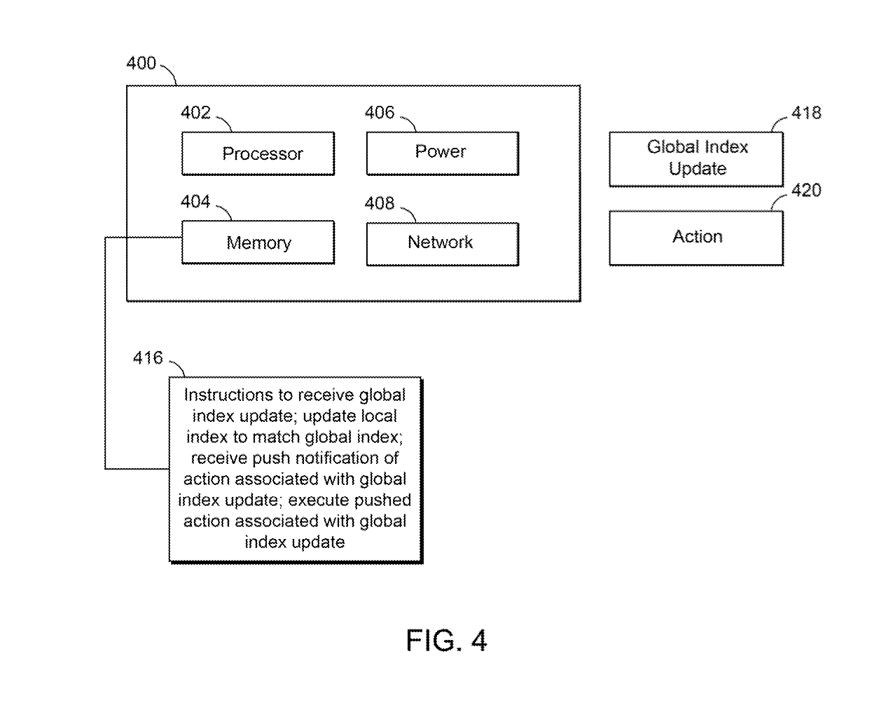

FIG. 4 illustrates a schematic representation of a computing device that may be used as a platform for receiving a global index update and a push notification of an action associated with the global index update, according to an example of the present disclosure.

In an example, device 400 comprises a processor or CPU 402, memory 404 (or machine-readable medium), power source 406, and network interface 408, all of which may be coupled by a bus or other interconnect. In some examples, device 400 may also comprise a computer readable medium, which may comprise an operating system, network applications, and/or an authentication function. In the case of a device such as a smartphone, tablet, or printer, device 400 may also comprise an input device, such as a touchscreen input.

Some or all of the operations set forth in the figures may be contained as machine-readable instructions as a utility, program, or subprogram in any desired computer readable storage medium, or embedded on hardware. In addition, the operations may be embodied by machine-readable instructions. For example, they may exist as machine-readable instructions in source code, object code, executable code, or other formats. The computer readable medium may also store other machine-readable instructions, including instructions downloaded from a network or the internet.

The computer-readable medium may also store machine-readable instructions that may perform basic tasks such as recognizing input from input devices, such as a keyboard or a keypad; sending output to a display; keeping track of files and directories on a computer readable medium; and managing traffic on a bus. The network applications may include various components for establishing and maintaining network connections, such as machine readable instructions for implementing communication protocols including but not limited to TCP/IP, HTTP, HTTPS, Ethernet, USB, and FireWire.

In an example where the device of FIG. 4 is a device for propagating a global index update, device 400 may include instructions, e.g., instructions 416, to carry out the steps of FIGS. 2 and 3. In the case where the device of FIG. 4 is a device for receiving a global index update, device 400 may include instructions to receive a global index update 418; update a local index to match the global index; receive a push notification of an action 420 associated with the global index update, e.g., from push server 112; and execute the pushed action associated with the global index update.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

What is claimed is:

1. A method of indexing software files on a computing device, comprising:
receiving, with a processor, a global file index update from a first registered device;
storing, in a memory, the global file index update from the first registered device;
propagating the global file index update received from the first registered device to a second registered device via a computer network;
determining, with the processor, an action associated with the global file index update; and
propagating the action to the second registered device.

2. The method of claim 1, wherein the global file index update comprises file metadata related to a file crawl of federated storage.

3. The method of claim 1, wherein the global file index update comprises metadata relating to a file storage location on federated storage.

4. The method of claim 1, wherein determining an action associated with the global file index update comprises determining a device capability.

5. The method of claim 1, further comprising instructing a remote device to execute the action associated with the global file index update.

6. A computing device comprising:
a processor;
a memory; and
a network interface,
wherein the memory comprises instructions executable by the processor to crawl a remote server and update a global file index of software files in the memory based on the remote server crawl; and
wherein the network interface is to propagate the global file index update to a registered device and propagate a file associated with the global file index update in the event that the registered device is capable of processing the file associated with the global file index update.

7. The system of claim 6, wherein the remote server is to store a collection of files associated with a user of the system.

8. The system of claim 6, wherein the Instructions executable by the processor are further to log in to the remote server with credentials associated with a user.

9. The system of claim 6, wherein the network interface is to further propagate the file associated with the global file index update to federated storage.

10. A non-transitory computer readable storage medium comprising a set of instructions executable by a processor to:
receive a global file index update from a remote device;
update a local file index to include the global file index update;
receive a push notification of an action associated with at least one update in the global file index; and
execute the action associated with the at least one update in the global file index,
wherein the global file index update includes metadata associated with a crawled file system.

11. The non-transitory computer readable storage medium of claim 10, wherein the crawled file system is stored on federated storage.

12. The non-transitory computer readable storage medium of claim 10, wherein the instructions are further to index a local device.

13. The non-transitory computer readable storage medium of claim 12, wherein the instructions are further to upload the local device index to a remote server.

14. The non-transitory computer readable storage medium of claim 10, wherein the instructions are further to register a device with a metadata repository.

15. The non-transitory computer readable storage medium of claim 10, wherein the action comprises a retrieve and open command.
